(19) United States
(12) Patent Application Publication
(10) Pub. No.: US 2026/0037361 A1
(43) Pub. Date: Feb. 5, 2026

(54) Machine Vision and Machine Learning-Based Error Diagnostics and Remediation of Electronic Devices

(71) Applicant: ZEBRA TECHNOLOGIES CORPORATION, Lincolnshire, IL (US)

(72) Inventor: Natalie Koenig, Lindenhurst, IL (US)

(21) Appl. No.: 18/789,612

(22) Filed: Jul. 30, 2024

(51) Int. Cl. G06F 11/07; G06N 20/20

(52) U.S. Cl. CPC G06F 11/0793; G06F 11/0733; G06F 11/079; G06N 20/20

(57) ABSTRACT

Machine vision-based technical support is provided herein. An example method includes receiving an image of an electronic device, the image including an output of the electronic device indicative of an error code associated with an operation of the electronic device, executing a first trained model to recognize the error code from the output included in the image, executing a second trained model to output an error diagnostic based on the error code recognized using the first trained model, in response to verification of the error diagnostic output by the second trained model, executing a third trained model to output at least one solution to remedy an error of the electronic device corresponding to the error code recognized using the first trained model, and retraining the third trained model based on whether the at least one solution was effective in remedying the error.

### BACKGROUND

Diagnosing and remediating errors in the operation for electronic devices can pose challenges, particularly for users with little technical background. Documentation is often technically dense and difficult to understand, and when communicating with representatives, difficulties can be found in attempting to effectively articulate the nature of a problem. Even after articulating the nature of the problem, remediating the errors in operation of electronic devices may be complicated, require special training or servicing, and/or the steps required to remedy the errors in operation may vary. These frictions of access and application of information result in countless lost hours for end users of electronic devices.

### SUMMARY

Systems, methods, and apparatuses are provided herein for machine vision and machine learning-based diagnostic and remediation of errors in electronic devices. In an example embodiment, a method is disclosed. The method comprises training a plurality of machine learning algorithms for a device diagnostic and remediation system to generate at least a first trained model, a second trained model, and a third trained model, the first trained model being trained using a first set of training data that includes at least images of outputs of a set of electronic devices paired with error codes for the outputs, the second trained model being trained using a second set of training data that includes at least images of electronic devices including outputs indicative of error codes paired with error diagnostics, and the third trained model being trained using a third set of training data that includes at least a set of possible solutions paired with error diagnostics, deploying the device diagnostic and remediation system on at least one of a user device or a server for execution, executing the device diagnostic and remediation system, wherein executing the device comprises receiving an image of an electronic device (e.g., via an image capturing device), the image including an output of the electronic device indicative of an error code associated with an operation of the electronic device, executing the first trained model to recognize the error code from the output included in the image, executing the second trained model to output an error diagnostic based on the error code recognized using the first trained model, in response to verification of the error diagnostic output by the second trained model, executing a third trained model to output at least one solution to remedy an error of the electronic device corresponding to the error code recognized using the first trained model, and retraining the third trained model based on whether the at least one solution was effective in remedying the error.

In a variation of this example embodiment, the electronic device is a printer and the second trained model is trained based on training data that includes printer error titles, printer error descriptions, images of printers including outputs indicative of printer error codes, printer types, and seed error diagnostics.

In a variation of this example embodiment, the electronic device is a printer and the third trained model is trained based on training data that includes printer error titles, groups of printers for which specific printer error diagnostics are applicable, cause of printer errors associated with printer error diagnostics, and seed solutions.

In a variation of this example embodiment, the method further comprises determining at least one of a model or a category of the electronic device from the image based on at least one of an outline of the electronic device and indicia on the electronic device, retrieving technical documentation corresponding to the electronic device, and displaying the technical documentation corresponding to the electronic device.

In a variation of this example embodiment, the first trained model is configured to recognize the error code using at least one of text recognition or image recognition, and the method further comprises searching an index of error codes of the electronic device for the error code, retrieving technical documentation corresponding to the error code, and displaying the technical documentation corresponding to the error code.

In a variation of this example embodiment, the method further comprises capturing a live video feed of the electronic device, displaying the live video feed of the electronic device, and overlaying at least one augmented reality tag onto the live video feed, wherein the at least one augmented reality tag is instructive of a corrective action associated with the at least one solution output by the third trained model.

In a variation of this example embodiment, the corrective action comprises at least two steps, and wherein the augmented reality tags are presented sequentially responsive to a preceding step being completed.

In a variation of this example embodiment, the method further comprises retrieving warranty information about the electronic device and displaying the warranty information.

In a variation of this example embodiment, the method further comprises storing a record of an error of the electronic device, retrieving information about previous errors experienced by the electronic device, predicting a future error of the electronic device, based on the previous errors of the electronic device, and sending an alert indicative of the future error to a user.

In a variation of this example embodiment, the method further comprises capturing a live video feed of the electronic device, displaying the live video feed of the electronic device, and overlaying at least one augmented reality tag onto the live video feed, wherein the at least one augmented reality tag guides a user through a tutorial of use for the electronic device.

In a variation of this example embodiment, the first trained model performs the determining by performing optical character recognition on an indicium affixed to the electronic device and querying, with the indicium, a database containing a library of indicia of known electronic devices to identify at least one of a model or category of the electronic device.

In a variation of this example embodiment, the method further comprises classifying, by first trained model, the electronic device by function based at least partially upon an outline of the electronic device captured in the image, selecting, by the first trained model, a fourth trained model specialized to devices of the classified function based at least in part upon the classification, and determining, by the fourth trained model, at least one of a particular instance or a model of the electronic device.

In a variation of this example embodiment, the method further comprises receiving a question from a user about the technical documentation and generating, via a language model and based at least partially upon the documentation, an answer to the question.

In another example embodiment, a system comprising a memory, an image capture device, and a processing device is disclosed. The processing device is configured to receive an image of an electronic device from the image capture device, the image including an output of the electronic device indicative of an error code associated with an operation of the electronic device, execute a first trained model to recognize the error code from the output included in the image, the first trained model being trained with a first set of training data including at least images of outputs of a set of electronic devices paired with error codes for the outputs, execute a second trained model to output an error diagnostic based on the error code recognized using the first trained model, the second trained model being trained with a second set of training data including at least images of electronic devices including outputs indicative of error codes paired with error diagnostics, in response to verification of the error diagnostic output by the second trained model, execute a third trained model to output at least one solution to remedy an error of the electronic device corresponding to the error code recognized using the first trained model, the third trained model being trained with a third set of training data, and retrain the third trained model based on whether the at least one solution was effective in remedying the error.

In a variation of this example embodiment, the electronic device is a printer and the second trained model is trained based on training data that includes printer error titles, printer error descriptions, images of printers including outputs indicative of printer error codes, printer types, and seed printer error diagnostics.

In a variation of this example embodiment, the electronic device is a printer and the third trained model is trained based on training data that includes printer error titles, groups of printers for which specific printer error diagnostics are applicable, cause of printer errors associated with printer error diagnostics, and seed solutions.

In a variation of this example embodiment, the processing device is further configured to determine, based at least in part upon at least one of a group including an outline and indicia on the electronic device, a model or category of the electronic device, retrieve technical documentation corresponding to the electronic device, and display the technical documentation corresponding to the electronic device.

In a variation of this example embodiment, the processing device is further configured to detect, in the image, an error code of the electronic device, determine, via character recognition, the error code, search an index of error codes of the electronic device for the error code, retrieve technical documentation corresponding to the error code, and display the technical documentation corresponding to the error code.

In a variation of this example embodiment, the processing device is further configured to capture, via the image capture device, a live video feed of the electronic device, display the live video feed of the electronic device, determine, based at least in part upon the technical documentation corresponding to the error code, a corrective action for the error code, and overlay at least one augmented reality tag onto the live video feed, wherein the at least one augmented reality tag is instructive of how to perform the corrective action.

In a variation of this example embodiment, the processing device is further configured to retrieve warranty information about the electronic device and display the warranty information.

In a variation of this example embodiment, the processing device is further configured to store a record of an error of the electronic device, retrieve information about previous errors experienced by the electronic device, predict a future error of the electronic device, based at least partially upon the previous errors of the electronic device, and send an alert indicative of the future error to a user.

In a variation of this example embodiment, the processing device is further configured to classify, by a first trained model, the electronic device by function based at least partially upon the outline of the electronic device captured in the image, select, by the first trained model, a fourth trained model specialized to devices of the classified function based at least in part upon the classification, and determine, by the fourth trained model, at least one of a particular instance or a model of the electronic device.

In a variation of this example embodiment, the processing device is further configured to receive a question from a user about the documentation and generate, via a language model and based at least partially upon the documentation, an answer to the question.

In still yet another example embodiment, the present invention is a non-transitory computer-readable medium storing instructions which, when executed by a processing device, cause the processing device to receive an image of an electronic device, the image including an output of the electronic device indicative of an error code associated with an operation of the electronic device, execute a first trained model to recognize the error code from the output included in the image, execute a second trained model to output an error diagnostic based on the error code recognized using the first trained model, in response to verification of the error diagnostic output by the second trained model, execute a third trained model to output at least one solution to remedy an error of the electronic device corresponding to the error code recognized using the first trained model, and retrain the third trained model based on whether the at least one solution was effective in remedying the error.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a block diagram of an example system for diagnosis and remediation of errors in operation of electronic devices, according to example embodiments of the present disclosure.

FIG. 2 illustrates a flowchart of an example method for diagnosis and remediation of errors in operation of electronic devices, according to example embodiments of the present disclosure.

FIG. 3 illustrates an example scenario in which a user interface of an electronic device is displaying information about the electronic device that has been recognized based upon an outline of the electronic device, according to example embodiments of the present disclosure.

FIG. 4 illustrates an example scenario in which a user interface of an electronic device is displaying information about the electronic device that has been recognized based upon indicia of the electronic device, according to example embodiments of the present disclosure.

FIG. 5 illustrates example scenario in which a user interface of an electronic device is displaying information about an error code which the electronic device is displaying, according to example embodiments of the present disclosure.

FIG. 6 illustrates an example model selection flow, according to example embodiments of the present disclosure.

FIG. 7 illustrates an example dataflow for answer generation, according to example embodiments of the present disclosure.

FIG. 8 illustrates an example networked implementation of a system for diagnosing and remediating errors in operation of electronic devices, according to example embodiments of the present disclosure.

FIG. 9 illustrates an example user interface home screen of a user device configured to diagnose and remediate errors in operation of an electronic device, according to example embodiments of the present disclosure.

FIG. 10 illustrates a flowchart of an example method for selecting a module, according to example embodiments of the present disclosure.

FIG. 11 illustrates a flowchart of an example method for detecting a device error, according to example embodiments of the present disclosure.

FIG. 12 illustrates a flowchart of an example method for generating solutions to remediate errors and refining solution generation, according to example embodiments of the present disclosure.

FIG. 13 illustrates a flowchart of an example method for recognizing an electronic device within a captured image and refining device recognition, according to example embodiments of the present disclosure.

FIG. 14 illustrates a flowchart of an example method for retrieving and displaying documentation about an identified device, according to example embodiments of the present disclosure.

FIG. 15 illustrates a flowchart of an example method for storing device records, according to example embodiments of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Systems, methods, and apparatuses of the present disclosure provide machine vision and machine learning-based diagnosis and remediation of errors in electronic devices. Existing techniques for diagnosing and remediating errors in operation of electronic device typically fall into one of two categories. In a first category, the end user attempts to diagnose and remediate errors in the operation of an electronic device, in some instance trying to search resources (such as a manual) for a solution. In a second category, an end user contacts or summons an agent or representative to attempt to diagnose and remediate the problem. Each of these existing techniques, however, poses significant technical challenges. In the first case, documentation-based technical support can be difficult for individuals with no technical background to navigate, and can be unworkable in situations where a malfunctioning device is particularly complex. In the second case, the ability of an end user to articulate an exact nature of a problem to a representative is often less than desirable, so phone-based support is often limited by an inability to examine a problem device. Further, phone and visit-based support is resource intensive and subject to factors such as regular business hours which can result in unacceptable downtimes of valuable devices. It is therefore desirable to implement a system which can inspect and diagnose a device rapidly and facilitate remediation of the error in operation of the electronic device without the need for outside human intervention and/or specialized training.

Systems, methods, and apparatuses of the present disclosure advantageously leverage emerging techniques in machine learning and machine vision to quickly identify a device within an image (e.g., a captured image, an image preview/live feed, or one or more frames of video), diagnose one or more problems of that device, then facilitate remediation of the one or more problems. By training one or more machine vision and machine learning models and employing augmented reality and/or language models to identify devices which may be encountered, diagnose the problems with the devices, and facilitate remediation of the one or more problems in the devices technical support can be quickly and effectively provided without the drawbacks of existing techniques as discussed above.

In one non-limiting example application, embodiments of the present disclosure inspect, diagnose, and facilitate remediation of printers. Printers, such as thermal printers, can pose unique challenges due to the nature and diversity of errors that can be encountered, which can include mechanical errors, electrical error, electromechanical errors, resource (e.g., media and ribbon) errors, and/or other errors. The steps of remediating such errors may vary by printer category/type, printer series, and/or printer model and there may several possible solutions to an error (which may result in a trial-and-error approach to remediating an error). Using machine vision and machine learning models trained using training data specific to printers can enable end users to diagnose errors in the operation of a printer, identify possible solutions to the errors, and remediate the errors. Some example printer errors include but are not limited to a ribbon out error, a media out error, a printhead under temperature error, an out of memory storing format error, a cover open error, a media jam error, a media wrap error, and/or other errors that affect an operation of a printer. The ribbon out error corresponds to an ink ribbon being depleted which may cause the printer to stop in the middle of a print job or may prevent a print job from starting. The media out error corresponds to the media being depleted but may also be indicative of a media jam or a missing label on a media roll where any one of these may result in the same error being output by the printer and may prevent the printer from detecting media in a print path when a print command or a feed command is executed preventing a print job from being performed. The printhead under temperature error indicates that the printhead is below an operating temperature for proper printing which may be, for example, a power supply issue, a printhead issue, and/or an environmental issue. The out of memory storing format error corresponds to the inability of the printer to store data in a specified memory location such that there is not enough memory to perform a requested print operation. The cover open error indicates that the sensor detects that the cover is open which prevents the printer from performing a print job which can indicate that the cover is open, not closed properly, and/or that the sensor is malfunctioning. Because an error in operation of a printer can have different causes and different solutions, embodiments of the systems described herein can advantageously identify and implement those solutions that are most likely to be successful in remediating the error. In some examples, embodiments of the system described herein can establish communication with a printer experiencing an error and can control the printer to cause the printer to perform the steps of a solution autonomously. In some examples, embodiments of the system described herein can establish communication with a printer experiencing an error and can control the printer to cause the printer to perform at least some of the steps of a solution autonomously while other steps of the solution can be performed manually by the user. In some examples, embodiments of the system described herein can render instructions and provide augmented reality view of the instructions overlaying a printer experiencing an error to guide a user through the solution.

As one non-limiting example, there may be several possible solutions to address an example media out error for a thermal label printer. One non-limiting example solution may include the steps of opening a printer cover, discarding a core of a depleted media roll (if necessary), loading a new roll, closing the printer cover, and feeding the media along the print path (e.g., in response to a designated button on the printer being selected or in response to a command from the system after it is confirmed that the cover has been closed), and resuming printing (e.g., in response to another designated button being selected or in response to a command from the system after it is confirmed that the media has been fed to a specified point in the print path).

Another non-limiting example solution may include the steps of opening the printer cover, observing there is a missing label between two other labels on a media roll, pulling or feeding the media past the missing label until the next label is positioned over a platen roller of the printer, closing the cover, feeding the media along the print path, and leaving the power of the printer on to avoid losing a print job. As such, an error code output by a printer can have different diagnoses and different solutions.

As used herein, a “device category” or “device type” refers categories and/or sub categories of devices, such as but not limited to a printers category and subcategories of printers, such as mobile printers, desktop printers, industrial printers, direct thermal printers, transfer thermal printers, ink jet printers, laser printers; a mobile computer category and subcategories of mobile computer categories mobile phones or computers, personal digital assistants, tablets, laptops; an autonomous robots category and subcategories of autonomous robots, such as autonomous mobile or ground robots, drones; a barcode scanners category and subcategories of barcode scanners, such as handheld barcode scanners, bioptic barcode scanners, fixed barcode scanners; and/or other categories and subcategories of electronic devices.

As used herein, a “device model” refers to devices having the same build parameters, specifications, and features usually but not necessarily identifiable by a name or number given to the devices of a device model. As used herein a “device series” refers to a group of different but related device models, e.g., that have similar build parameters and specification to each other but may have some different build parameters, specifications, and/or features. An example of a device series is the ZD600 printer series from Zebra Technologies Corporation and an example of a device model is the ZD621 from Zebra Technologies Corporation in the device series ZD600. Some device categories may not be associated with a device series or may not be associated with a device model.

Embodiments of the systems described herein can include one or more trained machine learning models that can be trained using sets of general and/or domain specific training data and can be re-trained using outputs generated by the trained machine learning models (e.g., using a feedback process). The training data utilized by embodiments of the present disclosure can include, for example, images of the devices from different perspectives, device category identifiers, device model identifiers, device series identifiers, technical documentation (e.g., user manuals, specifications, white papers), known error codes, device outputs for known error codes, known solutions corresponding to known error codes, and/or other data associated with different device categories, device series, and/or device models. As an example, for embodiments of the present disclosure configured to inspect, diagnose, and facilitate remediation of errors in the operation of printers, the training data can include domain specific training data for the printers including images of the printers from different perspectives, printer type identifiers, printer model identifiers, printer series identifiers, technical documentation (e.g., printer user manuals, printer specifications, printer white papers), known printer error codes, printer outputs for known error codes, known solutions corresponding to known printer error codes, and/or other data associated with different printer categories, printer series, and/or printer models. Different machine learning models may be trained with different training data, where the training data may overlap between different machine learning models and/or may be mutually exclusive relative to other machine learning models.

The trained machine learning models can be generated using one or more machine learning algorithms with the training data. Some examples of machine learning algorithms that can be used include, but are not limited to supervised learning algorithms, unsupervised learning algorithm, artificial neural network algorithms, association rule learning algorithms, hierarchical clustering algorithms, cluster analysis algorithms, outlier detection algorithms, semi-supervised learning algorithms, reinforcement learning algorithms and/or deep learning algorithms. Examples of supervised learning algorithms can include, for example, AODE; Artificial neural network, such as Backpropagation, Autoencoders, Hopfield networks, Boltzmann machines, Restricted Boltzmann Machines, and/or Spiking neural networks; Bayesian statistics, such as Bayesian network and/or Bayesian knowledge base; Case-based reasoning; Gaussian process regression; Gene expression programming; Group method of data handling (GMDH); Inductive logic programming; Instance-based learning; Lazy learning; Learning Automata; Learning Vector Quantization; Logistic Model Tree; Minimum message length (decision trees, decision graphs, etc.), such as Nearest Neighbor algorithms and/or Analogical modeling; Probably approximately correct learning (PAC) learning; Ripple down rules, a knowledge acquisition methodology; Symbolic machine learning algorithms; Support vector machines; Random Forests; Ensembles of classifiers, such as Bootstrap aggregating (bagging) and/or Boosting (meta-algorithm); Ordinal classification; Information fuzzy networks (IFN); Conditional Random Field; ANOVA; Linear classifiers, such as Fisher's linear discriminant, Linear regression, Logistic regression, Multinomial logistic regression, Naive Bayes classifier, Perceptron, and/or Support vector machines; Quadratic classifiers; k-nearest neighbor; Boosting; Decision trees, such as C4.5, Random forests, ID3, CART, SLIQ, and/or SPRINT; Bayesian networks, such as Naive Bayes; and/or Hidden Markov models. Examples of unsupervised learning algorithms can include Expectation-maximization algorithm; Vector Quantization; Generative topographic map; and/or Information bottleneck method. Examples of artificial neural network can include Self-organizing maps. Examples of association rule learning algorithms can include Apriori algorithm; Eclat algorithm; and/or FP-growth algorithm. Examples of hierarchical clustering can include Single-linkage clustering and/or Conceptual clustering. Examples of cluster analysis can include K-means algorithm; Fuzzy clustering; DBSCAN; and/or OPTICS algorithm. Examples of outlier detection can include Local Outlier Factors. Examples of semi-supervised learning algorithms can include Generative models; Low-density separation; Graph-based methods; and/or Co-training. Examples of reinforcement learning algorithms can include Temporal difference learning; Q-learning; Learning Automata; and/or SARSA. Examples of deep learning algorithms can include Deep belief networks; Deep Boltzmann machines; Deep Convolutional neural networks; Deep Recurrent neural networks; and/or Hierarchical temporal memory.

Embodiments of the systems described herein can perform imaging processing and/or machine vision to process the images and extract features from the images. For example, embodiments of the systems described herein can, for example, use Stitching/Registration, Filtering, Thresholding, Pixel counting, Segmentation, Inpainting, Edge detection, Color Analysis, Blob discovery & manipulation, Neural net processing, Pattern recognition, Optical character recognition, blurring, normalized lighting, greyscaling, OTSU, thresholding, erosion/dilation, convert correct hull, contour detection, blob/mass calculation normalization, and/or Gauging/Metrology. Using the image processing and/or machine vision techniques, embodiments of the systems described herein can extract data including one or more features of imaged electronic devices, e.g., contours, outlines, dimensions, labels, indicators, displays, glyphs, indicia, and/or other features. These extracted features can be used an inputs to the one or more trained machine learning models to facilitate, for example, inspection, diagnoses, and/or remediation of error in operation of the imaged electronic device.

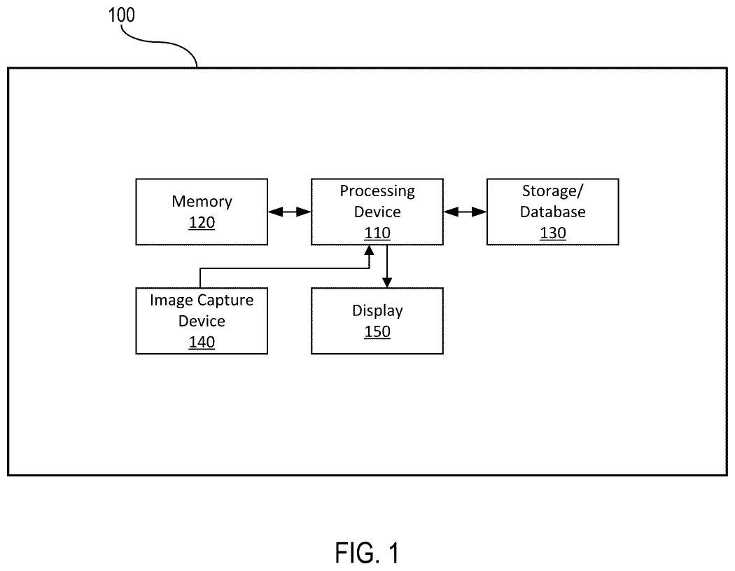

FIG. 1 illustrates a block diagram of an example system 100 for diagnosing and remediating errors in electronic device, according to example embodiments of the present disclosure. In this example system 100, a processing device 110 communicates with a memory 120 storing instructions. The processing device 110 may also communicate with one or more storage database(s) 130 which may store data including but not limited to known error codes for device categories, series, and/or models; known device outputs for known error codes for device categories, series, and/or models, known solutions for the error codes for device categories, series, and/or models, records of queries about one or more device categories, series, and/or models, records of errors of one or more device categories, series, and/or models, and/or warranty information about one or more devices. An image capture device 140 may collect image and/or video data for processing by the processing device 110. The processing device 110 may interact with a user via a display 150. The display 150 may be touch sensitive and thus able to send data about user actions to the processing device 110. In some embodiments, other input/output (I/O) peripherals may be employed to facilitate user interaction with the processing device 110.

Using the extracted features, the processing device 110 can be configured to determine a device category, device series, device model, and/or an error code being output by the device that was imaged. This extracted information may be used as inputs to one or more trained machine learning models which can facilitate, e.g., remediation of errors in operation of the device that was imaged. In some example embodiments, the database 130 may store records of one or more historical errors associated with one or more devices. In these scenarios, historical error records may also be employed by one or more trained machine learning models executed by the processing device 110 to predict future errors and to alert users of the predicted errors before they happen.

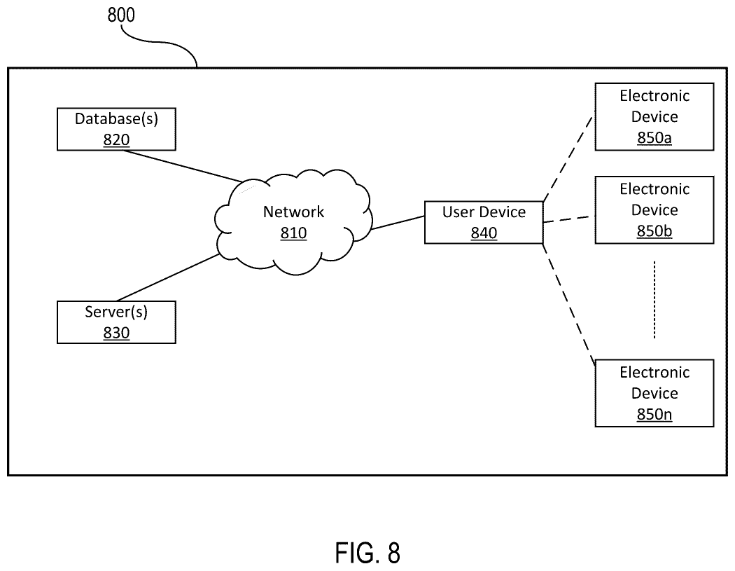

In an example embodiment, executable code may be installed on the system 100 and stored in the memory 120. The code can be configured to be executed by the processor 110 to perform one or more processes as described herein using trained machine learning and machine vision models, augmented reality, and/or language models included in the application or executing on a server in communication with the system 100 (e.g., as shown in FIG. 8) to inspect devices; identify device categories, series, models, and/or specific device identifiers (e.g., serial numbers, MAC addresses, etc.); diagnose errors in operation of electronic devices; and/or facilitate remediation of the errors in operation. The system 100 can utilize the trained models in combination or sequence to generate one or more intermediate outputs and a final output. As an example, an intermediate output from one of the trained models can be utilized as an input (or the input can be derived from the intermediate output) to different one of the trained models and the different one of the trained models can generate a final output or can generate another intermediate output that will be used as an input to yet another trained model. As another example, two or more trained models can be utilized concurrently to generate final outputs or intermediate outputs (e.g., that can form or be used to form an input to another trained model, such as a model that is trained to select one of the outputs as the final output) or final outputs based on identical or different inputs.

As another example, the system 100 may be configured to diagnose an error in operation of an electronic device imaged by the image capture device 140. Using the imaged electronic device as an input, a trained identification machine learning model can identify a device category, series, and/or model associated with the imaged electronic device. Once the device category, series, and/or model is determined based on an output of the trained identification machine learning model, another trained assessment machine learning model can use the device category, series, and/or model as an input in combination with an imaged output of the electronic device and can output an error code for the electronic device. The device category, series, and/or model and the error code can be used as an input to yet another trained diagnostic machine learning model of the system, which can output a diagnosis of the error in operation of the electronic device. Subsequently, the diagnosis of the error can be used as an input to still another trained solution machine learning model, and the trained solution machine learning model can output a response that may include one or more possible solutions for remediating the error. The trained solution machine learning model can rank the possible solutions based on a likelihood of the solutions to resolve the error. In one example, the one or more trained diagnostic and/or solution machine learning models can be trained to emphasize historical data regarding errors previously encountered by electronic devices of the device category, device series, and/or device model that have been identified for the device category, series, and/or model associated with the imaged electronic device and solutions that previously resolved the previously encountered errors may be ranked higher than other solutions when the particular errors are encountered. The response with the one or more possible solutions can be rendered on the display 150 by the processing device 110 and the system 100 can allow the user to select one of the possible solutions or the processing device 110 can initiate the highest ranking solution in the list of possible solutions.

For embodiments in which the system 100 is configured to inspect, diagnose, and remediate errors in operations of printers, the trained solution learning model may be trained based on training data that includes printer error titles, groups of printers for which specific printer error diagnostics are applicable, cause of printer errors associated with printer error diagnostics, and/or seed solutions. For example, training data for the trained solution learning model may include but is not limited to a list of possible printer errors linked to an index of possible printers. In such a scheme, each possible printer error may be accompanied by a list of a subset of the possible printers for which that respective possible printer error may be applicable. Each possible printer error may also be accompanied by a cause of the respective possible printer error, which may be provided as an integer (e.g. a “1” indicating that a printer firmware update is required, a “2” indicating that a ribbon is jammed, etc.) or as a human-readable description. In the latter case, the trained solution machine learning model may be operable to process human readable descriptions in a manner similar to that of a language model. Seed solutions may be provided in the training data, which may include but are not limited to examples of printer errors paired with solutions which resolved those printer errors.

Once the selected solution is initiated, the system can provide steps for the user to follow to resolve the error. In one example, the system 100 can image the electronic device and use augmented reality, as described herein, to provide a visual overlay on the electronic device that correspond to the steps of the selected solution. In one example, in response to initiation of a solution, the system 100 can establish communication with the electronic device and can control components and operations of the electronic device. As an example, the solution can include multiple steps to be performed to resolve the error and the system can send commands or instructions to the electronic device to perform the steps or at least some of the steps. For an error requiring human intervention for at least some of the steps, the system 100 can perform some of the steps autonomously and a user can perform some of the steps manually. To ensure there is a proper sequence and handoff between steps, the system can mediate the steps of the solution by requiring the electronic device confirm an automated step has been performed and/or requiring a user to confirm that the manual step has been performed. Confirmation that the manual step has been completed can be received as input from the user, can be determined based on feedback from the electronic device, and/or can be confirmed by imaging the first electronic device after the step has been performed, extracting features from the image, inputting the extracted to a trained machine learning model which can be configured to output a response that the step was, for example, complete, incomplete, or incorrectly performed.

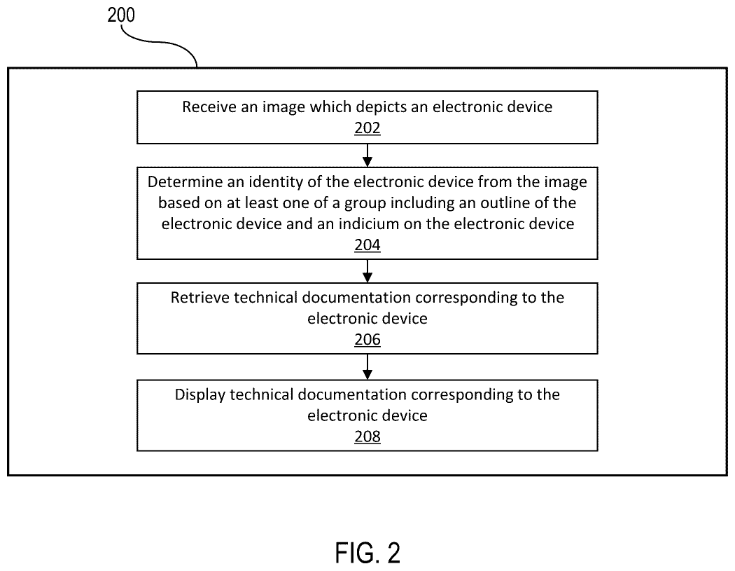

FIG. 2 illustrates a flowchart of an example method 200, according to example embodiments of the present disclosure. It will be appreciated that the method 200 is presented in such a manner as to provide clarity, and as such may exclude certain sub-steps and/or additional actions which may be performed in connection with the method 200. It will also be appreciated that other example embodiments of the present disclosure may exclude any or all of the steps of the method 200, and that the method 200 constitutes one of many possible methods which may serve as example embodiments of the present disclosure.

The method 200 begins at block 202, at which an example processing device receives an image which depicts an electronic device. For example, the image capture device 140 may image the electronic device and the processing device 110 may receive a camera/video feed of an environment of an example system 100 from the image capture device 140. In one example, the video feed may contain one or more images of a printer.

At block 204, the example processing device determines an identity of the electronic device (e.g., a device category, device series and/or device model) based on features extracted from the image using one or more trained machine learning algorithm in combination with image recognition algorithms. For example, features that can be extracted and utilized by the trained machine learning model are an outline of the electronic device, an indicium on the electronic device, and/or other features or characteristics of the electronic device. For example, the processing device 110 may employ the one or more trained machine learning models to identify the manufacturer, category, series, model, and/or serial number of the imaged printer based upon a shape of the printer and/or indicia on a housing of the printer. In one example, there can be several different possible categories, series, and models of printers that can be imaged from a single manufacturer and the one or more trained machine learning device can be trained using training data specific to the manufacturer of the printers or from multiple manufacturers and the one or more trained machine learning models can be trained using training data specific to each of the manufacturers of the printers as described herein.

As an example, the processing device 110 may execute a trained machine learning model trained using a supervised learning technique with training data including various outlines of devices form different perspectives or points-of-view which the system 100 is expected to encounter paired with identity data (device category, series, and/or model data) of respective devices associated with the respective outlines. Another machine learning model may also be trained in the same manner with training data including various indicia of devices which the system 100 is expected to encounter paired with identity data (e.g., a device category, device series and/or device model) of respective devices associated with the respective indicia. The machine learning model may be continually trained with feedback regarding whether a device has been correctly identified. As one example, the one or more machine learning models may incorrectly identify a device category, series, or model of a device causing the system 100 to receive feedback indicative of an incorrect identification. As part of the feedback, the system 100 may receive one or more images of the electronic device captured via the image capture device of the system 100 paired with corrected identity data of the electronic device associated with the respective images. This feedback may be used as a negative reinforcement, thereby improving an accuracy of future predictions. As another example, the machine learning model may correctly identify a device which may be used as a positive reinforcement, thereby improving an accuracy of future predictions.

At block 206, based on the determined identity of the electronic device (e.g., a device category, device series and/or device model), the example processing device (e.g., processing device 110) can provide a selectable link to a URL at which a knowledge base corresponding to the device category, series, and/or model of the electronic device with technical documentation can be retrieved and the processing device can render the knowledge base on a display (e.g., display 150). As another example, the processing device 110 may query a database 130 containing user manuals, warranty information, and historical error data for a variety of different electronic devices. The database 130 may return user manual data, warranty data, and historical error data about the identified device.

At block 208, an example display displays data from the knowledge base or retrieved from the database 130 corresponding to the imaged electronic device. For example, the processing device 110 may employ the display 150 to display a live video feed of images from the image capture device 140 depicting the electronic device. The processing device 110 may then overlay one or more augmented reality tags on the live video feed to, for example, direct a user through a tutorial providing steps for using the electronic device. In an example, the processing device 110 may detect via the live feed of images that the electronic device is not powered on, and may place an augmented reality tag which reads “press this button on device” in or near a portion of the video feed representative of a power button of the electronic device.

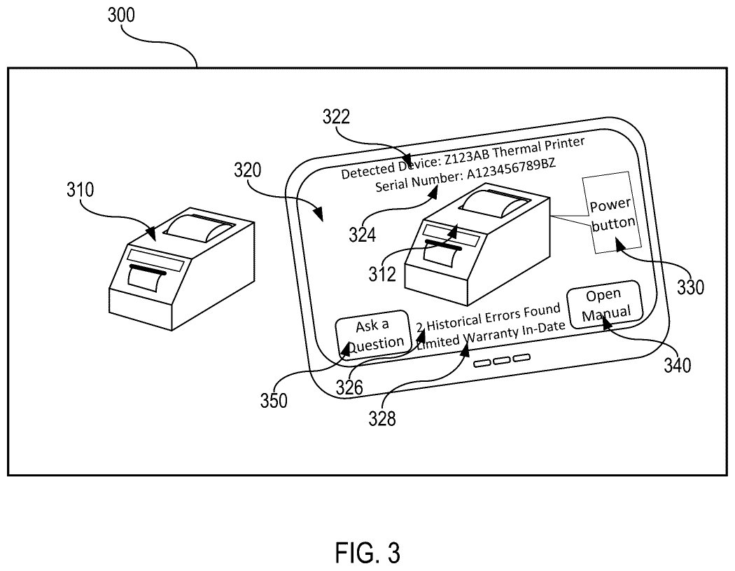

FIG. 3 illustrates an example scenario 300 in which a user interface 320 of an automated system (e.g., system 100) is displaying information about a device 310 that has been recognized based upon an outline of the device, according to example embodiments of the present disclosure. It will be appreciated that the user interface 320 as illustrated herein is presented for the purpose of illustrating various features contemplated herein, and that particular placements of interactive features, designs of user interface 320 screens, and other cosmetic components of the user interface 320 may vary drastically from what is illustrated without departing from the spirit or scope of the present disclosure.

In this example scenario 300, a user has aimed an image capture device of an automated system (e.g., system 100 shown in FIG. 1) at an electronic device 310. The automated system may detect an outline of the electronic device 310 and/or indica on the electronic device and determine an identity of the electronic device 310 (e.g., a device category, series, and/or model) using one or more trained machine learning models that receive the outline and/or indicia extracted from images captured by the image captured device. The identity of the electronic device as output by the one or more trained machine learning models may be displayed by the user interface 320 in a “detected device” section 322, illustrated here at the top of the user interface 320. In some example embodiments of the present disclosure, the user may be able to access one or more screens of the user interface 320, for example by tapping or clicking the “detected device” section 322, which allows the user to, for example, indicate that the automated system has incorrectly identified the electronic device 310. The user interface 320 may also display a serial number 324 of the electronic device 310 as well if applicable, which may be identified based upon indicia on the electronic device that were extracted from images of the electronic device 310.

The user interface 320 may display a live video feed 312 of the electronic device 310, and may overlay one or more augmented reality tags 330 upon the live video feed 312. In this example scenario 300, an augmented reality tag 330 showing a user the location of a power button is overlayed. As the user performs actions with the electronic device 310, additional augmented reality tags 330 may be displayed directing the user to perform subsequent actions. These augmented reality tags 330 may move across the live video feed 312 in coordination with a change of perspective of the live video feed 312. For example, if the user moves the system such that a side of the electronic device 310 which mounts the power button is visible, the augmented reality tag 330 may move to specifically indicate the location of the power button on the live video feed 312. When the user presses the power button, the augmented reality tag 330 may be replaced with a new augmented reality tag 330 showing the user, for example, how to adjust a backlight brightness.

At a bottom of the example user interface 320 a number of historical errors 326 may be displayed, wherein the number of historical errors 326 may correspond to a number and/or types of errors which the electronic device 310, a device category of the electronic device 310, a device series of the electronic device 310, and/or device model the electronic device 310 has encountered previously during a service life of the electronic device 310, the device category, the device series, and/or the device model and which have been logged. In some example embodiments of the present disclosure, the user may be able to access one or more screens of the user interface 320, for example by tapping or clicking the number of historical errors 326, which displays particular information about respective recorded errors. A warranty status 328 may also be displayed for a particular electronic device (e.g., based on a serial number of the device imaged), and additional screens of the user interface 320 may be accessible, for example by clicking or tapping the warranty status, which provide additional information about the electronic device 310 warranty status.

An “open manual” button 340, which may be a virtual button, may be provided to allow a user to directly access documentation about the electronic device 310. This documentation may be provided in textual form, pictorial form, via augmented reality tags, via other means, or combinations thereof, and this function may be used to access one or more augmented reality-based tutorials associated with the device 310. Documentation accessed via the “open manual” button 340 may be locally stored, such as on a hard drive or solid state drive, or may be accessed remotely, such as by querying a database for appropriate documentation or navigating to a specified URL.

The user interface 320 may also provide a functionality for the user to query documentation about the electronic device 310 in a natural language-manner. For example, an “ask a question” button 350, which may be a virtual button, may allow a user to access a chat-like interface. The chat-like interface may allow the user to converse with a machine learning-based language model to query technical documentation about the electronic device 310. For example, the user 310 may wish to know how to change a paper roll of the electronic device 310, and may type “how do I change the paper roll” into the chat-like interface. The language model may receive this query and access user manual data associated with the electronic device 310 to generate an appropriate answer. In the example scenario 300, the language model might respond with “would you like me to initiate a paper change tutorial?”. When the user responds with “yes”, the language model might initiate an augmented reality tag 330-based tutorial instructing the user on how to open a housing of the electronic device 310, remove an empty paper roll, and properly install a fresh paper roll.

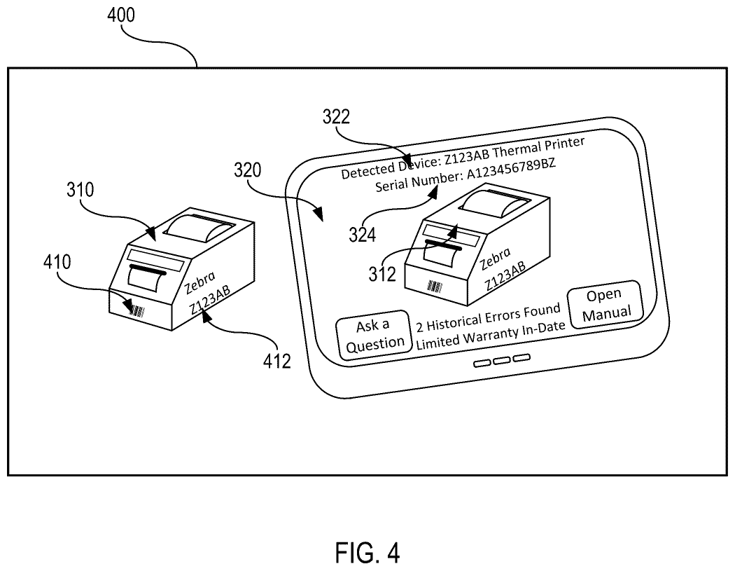

FIG. 4 illustrates an example scenario 400 in which a user interface 320 is displaying information about a device 310 that has been recognized based upon indicia of the device 310, according to example embodiments of the present disclosure. In the example scenario 400, the indicia include a barcode 410 and human-readable text 412, both on a housing of the device 310. The detected device 322 may in this case be extracted from the human readable text 412. The human-readable text 412 and the barcode 410 may be detected by a machine learning model trained to detect and identify a variety of types of indicia. For example, the machine learning model may be a classifier trained on data including but not limited to images of barcodes (e.g., 1D and 2D barcodes), and human-readable markings (e.g. text or other indicia). The machine learning model may, for example, identify and segment indicia from a live video feed 312 and provide segmented images of identified indicia to a processing device for analysis. For example, a segmented image of the barcode 410 may be sent to a decoder module for payload extraction while a segmented image containing the human-readable text 412 may be sent to an optical character recognition (OCR) module for analysis.

Although illustrated herein with the barcode 410 encoding the serial number 324 and the human-readable text 412 encoding the detected device 322, it will be appreciated that any combination of indicia may be used in any quantity to encode any practical amount of data. For example, the barcode 410 may encode both the detected device 322 and the serial number 324. It will also be appreciated that simply decoding the serial number 324 from the barcode 410 may allow a system to reference a database matching serial numbers 324 to detected devices 322, thereby rendering analysis of the human readable text 412 redundant in this example. In such cases, it may be desirable to cross-reference information between differing sources (e.g. the barcode 410, the human-readable text 412, an outline of the device 310, one or more databases containing data about the device 310) to ensure that no discrepancies are present. Should a discrepancy arise, the system may provide the user with an error message, display data as agreed upon by the majority of sources (if applicable), display conflicting data, or take another action as appropriate.

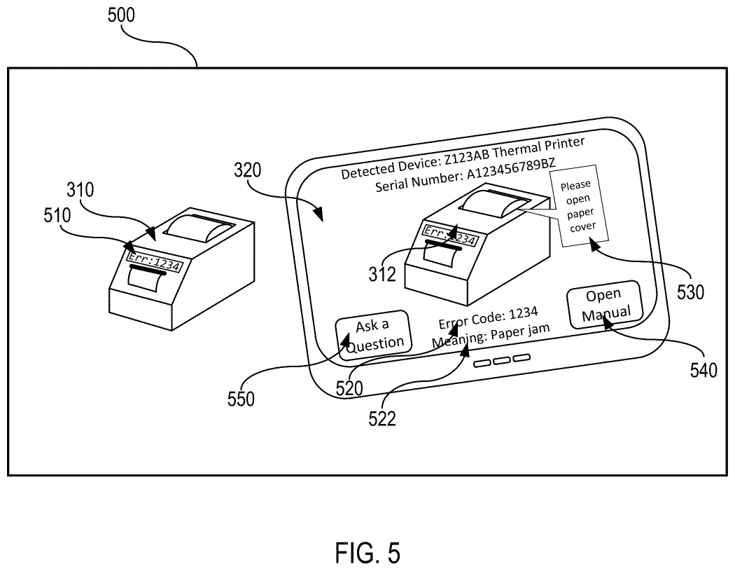

FIG. 5 illustrates example scenario 500 in which a user interface is displaying information about an error code 520 which an electronic device (e.g., electronic device 310) is displaying, according to example embodiments of the present disclosure. In the example 500, the device 310 possesses a display 510 which is indicating that an error has occurred. A system in accordance with an example embodiment of the present disclosure is displayed which may image the display of the electronic device 310 and using one or more trained machine learning models can extract features from the display corresponding to a detected error code 520 displayed on the display 510. The system may then display the error code 520 and/or information about the error code (e.g., a meaning 522 of the error code) on a user interface 320. While the present example, illustrates an indication of an error being output from the device 310 via the display 510, the device 310 can output indications of errors via other components, such as for example, indicator lights and/or speakers (or piezoelectric devices) and the system one or more machine learning models of the system can be trained to determine and output the error code and information about the error. As an example, the indicator lights may be energized and de-energized in a pattern or sequence and the pattern or sequence can be extracted from images of the electronic device, which then are input to the trained machine learning model which can output the error code and information about the error. As another example, the system (e.g., system 100) can include a microphone that captures the sound output from the speakers (or piezoelectric devices) which can be input to a trained machine learning model which processes the sound and outputs an error code and information about the error. The user interface may provide the user with an opportunity to confirm that the output of the machine learning model correctly identified the error code and/or information about the error code and may allow the user to provide feedback to the system which can be used to retrain the machine learning model.

In the example scenario 500, the device 300 is a printer 300 experiencing a paper jam. The printer 300 outputs “1234” as an error code 520 on a built-in display 510 to indicate to a user that a paper jam has occurred, which is recognized by the system and translated into a user-friendly format for display on the user interface 320. The system may proceed to automatically initiate an augmented reality tag 530-based step-by-step instructions to the user for fixing the paper jam, while the user interface 320 may provide options for the user to ask questions 550 in a natural language format (via a language model) and access further documentation 540. In one example, the system can establish a communication link with the printer and can control an operation of the printer to perform at least some of the instructions autonomously and/or received feedback from the printer to confirm a user has performed a step in the instructions correctly. As an example, for a paper jam, the after the user selects a solution to fix the paper jam, the system can establish a communication link with the printer and control the printer to reverse the feed direction of the paper in the printer, after which the next instruction can be presented to the user to open a cover to the printer, which may be visually depicted to the user on the display of the system using augmented reality. When the user opens the cover, a sensor in the printer can detect that the cover is open and can transmit a message to the system indicating that the cover is open such that the system can confirm that the step has been completed and/or the system can confirm that the cover has been opened using machine vision. The step-by-step instructions can continue where the system controls some of the steps autonomously and where the user performs some of the steps manually until the solution is completed.

In some embodiments of the present disclosure, the device 310 may possess one or more lights and/or speakers (or piezo electric devices) for indicating errors rather than or in addition to the display 510. In such embodiments, the system may utilize a machine learning model to locate the lights and decode a meaning of an illumination pattern thereof and/or to record sounds output by the speakers (or piezoelectric devices) and decode a meaning of the sounds. In some embodiments, the indicator lights can appear as icons with different colors and patterns, where the trained machine learning model can received images with the illuminated icons and can decode a meaning of the illuminated icons. Similarly, a machine learning model (which may be a same or different machine learning model as that which identifies the device 310 and which may also or alternatively be a same or different machine learning model as that which locates and decodes the lights) may be employed to locate and decode error codes 520 on the display 510. Similarly, an option may be provided to indicate that an incorrect or invalid error code 520 has been output by the machine leaning model.

Machine learning models for detecting and decoding error codes 520 in accordance with the present disclosure may be trained with supervised, semi-supervised, or unsupervised learning techniques. Any data may be included in training datasets for any machine learning model herein, but data containing images of devices 310 in various error states may be of particular utility when training models for detecting and decoding error codes 520. In some example embodiments, a separate machine learning model may be trained for each respective category, series, or model associated with the devices (e.g., device 310 being one of the devices) which the system is expected to encounter (e.g. a model may be trained specifically to detect errors in a specific category, series, and/or model of printers). In other example embodiments, a general model may be trained to detect error codes and states in a variety of different categories of devices.

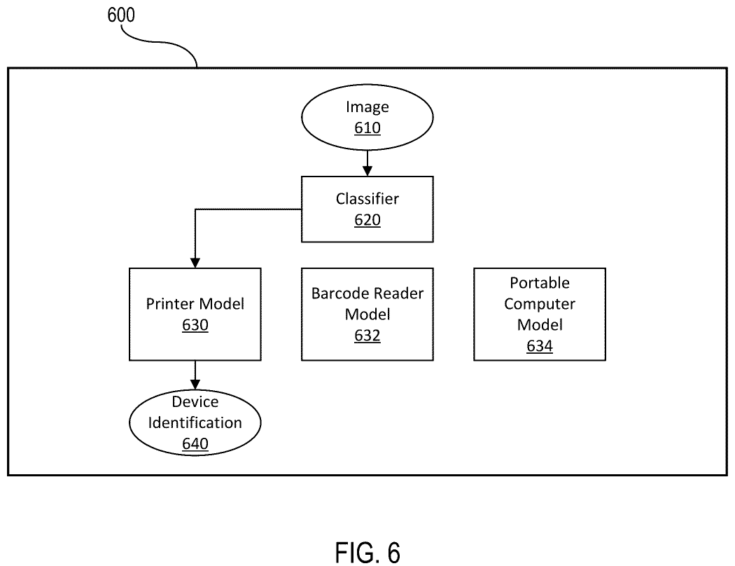

FIG. 6 illustrates an example model selection flow 600, according to example embodiments of the present disclosure. In this example, an image 610 is received from an image capture device by a processing device (see FIG. 1). The image 610 may contain a depiction of an electronic device, and the image 610 may be analyzed by a classifier 620 configured to determine a category/type of the electronic device. The classifier 620 may be a machine learning model trained with supervised or semi-supervised learning techniques on training datasets which include, for example, images of various categories electronic devices paired with corresponding electronic device categorizations. In this example, the classifier 620 may be configured to identify the image 610 as a depiction of a printer, a depiction of a barcode reader, or a depiction of a personal computer, tablet, or mobile device. The classifier 620 may also be configured to determine that no electronic device or an electronic device outside of a predefined category or categories is depicted in the image 610, and may output a “no device” or “unknown” category when such a determination is made.

An output of the classifier 620 indicative of a device of a predefined category being present in the image of 610 may cause an appropriate second-stage model to be selected in accordance with the output category. In this example, a printer identification model 630, a barcode reader model 632, and a portable computer model 634 may be provided. The classifier 620 may detect that a printer is depicted in the image 610 and generate an output which causes the image 610 to be passed to the printer model 630. The printer model 630, the barcode reader model 632, and the portable computer model 634, along with any other models accessible to the classifier 620, may be trained with supervised, semi-supervised, or unsupervised techniques on training datasets which may include images of various devices within the respective categories which may be accompanied by labels corresponding to a respective device model for each image.

Once the image 610 has been passed to a category-specific model (e.g. the printer model 630), the category-specific model may determine a particular device which is being depicted in the image 610 and output a device identification 640. Although the data flow 600 depicts a two-stage device identification 640 structure where a first-stage classifier 620 feeds into a second-stage printer model 630, it will be appreciated that any number of stages may be included in the data flow 600. For example, in some embodiments the classifier 620 may be configured to directly output a device identification 640, while in other embodiments, additional stages of models may be included between the classifier 620 and the printer model 630, before the classifier 620, and/or after the printer model 630.

The second-stage printer model 630 may be trained based on training data that includes but is not limited to error titles, error descriptions, images of printers including outputs indicative of error codes, printer types, and seed error diagnostics. For example, a title, code, and description of a ribbon out error in a Z123 printer may be accompanied by various images and/or audio recordings of Z123 printers experiencing a ribbon out error along with seed error data such as but not limited to images of the Z123 printer experiencing a ribbon out error paired with data about the ribbon out error.

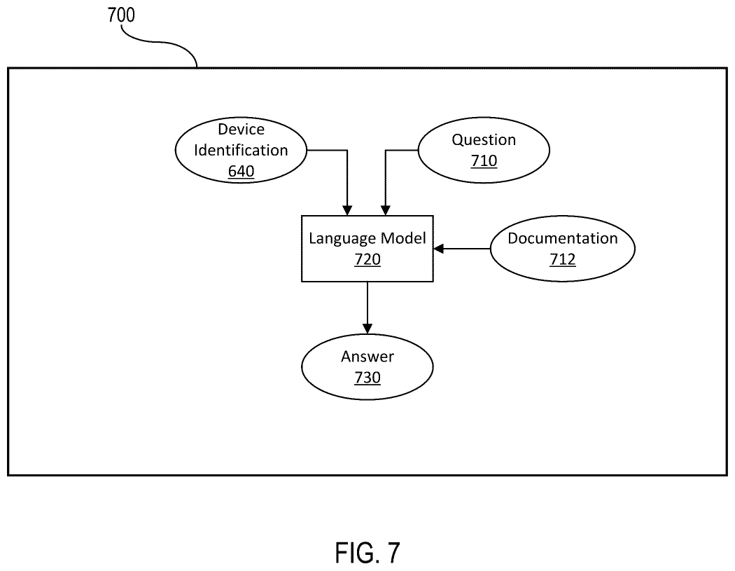

FIG. 7 illustrates an example dataflow 700 for answer 730 generation, according to example embodiments of the present disclosure. In this example, a language model 720 may receive a device identification 640 from one or more classifiers (see FIG. 6) along with a question 710 from a user, which may be in a conversational format, about the device indicated in the device identification. The language model 720 may retrieve documentation 712 about the device when generating an answer 730, which may be generated in a similar conversational format and style to that of the question 710.

The language model 720 may be an off-the-shelf language model trained for general purpose use or may be a custom-trained model specifically trained and configured to answer questions 710. For example, the language model 720 may be trained on conversational data from previous technical support interactions. The language model 720 may be in communication with one or more databases, which may be local or remote, and which may contain technical documentation 712 about one or more devices which the language model 720 may be expected to encounter.

FIG. 8 illustrates an example networked implementation of a system 800 for automating inspection, diagnostics, and error remediation for electronic device with machine vision and trained machine learning models, as described herein, according to example embodiments of the present disclosure. In this example implementation, a user device 840 communicates over a network 810 with at least one server 830 and at least one database 820. The user device 840 may be configured to identify, analyze a state of, and/or provide information to a user about a plurality of electronic devices 850a-n. As an example, the user device 840 may be configured to identify a first electronic device 850a (e.g., a device category, device series, device model, and/or specific device). This may involve the user device 840 sending image data (e.g., one or more images) of the first electronic device 850a to a server 830 via the network 810. The image data can include images of the housing of the first electronic device 850a and/or images including indicia on the housing of the first electronic device 850a. The server 830 may execute one or more trained machine learning models which are configured to extract features from the image(s) and to identify the first electronic device 850a based on the extract features. The trained machine learning model(s) can output a response identifying a device category, device series, and/or device model of the first electronic device, which can be transmitted via the network 810 from the server 830 to the user device 840. As another example, the user device 840 may be configured to diagnose an error of the first electronic device 850a after the device category, series, and/or model associated with the first devices has been identified. This may involve the user device 840 sending image data (e.g., one or more images) of the first electronic device 850a and/or sound data output by the first electronic device 850a to the server 830 via the network 810. The image data can include images including an output of the first electronic device and/or the sound data can include sound output by the first electronic device 850a. The server 830 may execute one or more trained machine learning models which are configured to extract features from the image(s) and/or sound and to determine an error code and information about the error based on the extract features. The trained machine learning model(s) can output a response corresponding to the error in operation of the first electronic device, which can be transmitted via the network 810 from the server 830 to the user device 840. As another example, upon determining diagnosing the error in operation of the first electronic device 850a, the server 830 can execute one or more trained machine learning models using the identified error in operation and the device category, series, and/or model as an input, and the one more trained machine learning models can output a response that include one or more possible solutions for remediating the error. The one or more trained machine learning models can rank the possible solutions based on a likelihood of the solutions to resolve the error. In one example, the one or more trained machine learning models can be trained to emphasize historical data regarding errors previously encountered by electronic devices of the device category, device series, and/or device model that have been identified as being associated with the first electronic device 850a and solutions that previously resolved the previously encountered errors such that these solutions may be ranked higher than other solutions when the particular errors are encountered. The response with the one or more possible solutions can be sent to the user device 840 to be rendered on a display of the user device 840 and the user device 840 can allow the user to select one of the possible solutions or the user device 840 can initiate the possible solution with the highest ranking.

Once the selected solution is initiated, the user device 840 in communication with the server 830, can provide steps for the user to follow to resolve the error. In one example, the user device 840 can image the first electronic device 850a and use augmented reality, as described herein, to provide a visual overlaid on the electronic device that correspond to the steps of the selected solution. In one example, in response to initiation of a solution, the user device 840 and/or server 830 can establish communication with the first electronic device 850a and can control components and operations of the first electronic device 850a. As an example, the solution can include multiple steps to be performed to resolve the error and the user device 840 and/or server 830 can send commands or instructions to control the first electronic device to perform the steps or at least some of the steps. For an error requiring human intervention for at least some of the steps, the user device 840 and/or the server 830 can perform some of the steps autonomously and a user can perform some of the steps manually. To ensure there is a proper sequence and handoff between steps, the user device 840 and/or server 830 can mediate the steps of the solution by requiring the first electronic device 850a confirm an automated step has been performed and/or requiring a user to confirm that the manual step has been performed. Confirmation that the manual step has been completed can be received as input from the user, based on feedback from the first electronic device 850a, and/or can be confirmed by imaging the first electronic device 850a after the step has been performed, extracting features from the image, inputting the extracted to a trained machine learning model which can be configured to output a response that the step was, for example, complete, incomplete, or incorrectly performed.

In some embodiments, the server(s) 830 may be replaced with one or more distributed computing nodes, and several machine learning models may be executed in parallel on a distributed computing system for the purpose of fulfilling queries from various user devices 840. Such a distributed computing system may also be configured to continuously or periodically train the machine learning models in either an in-place configuration, wherein a machine learning model is further trained with newly acquired data while in service, or a from-scratch configuration, wherein newly acquired data is added to an existing training dataset and a new model is trained from the updated dataset.

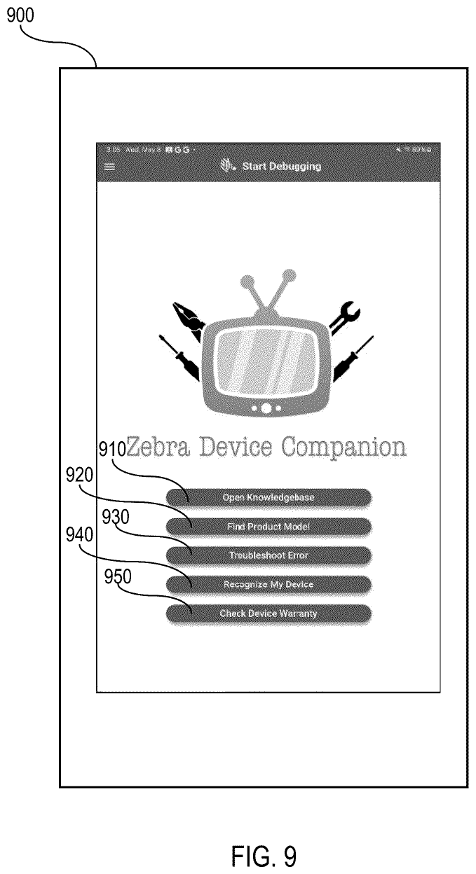

FIG. 9 illustrates an example user interface home screen 900, according to example embodiments of the present disclosure. As illustrated, a first virtual button 910 allows a user to access a knowledgebase. Selecting the first virtual button 910 may present a user with one or more menus allowing the user to access and navigate documentation which is accessible to the user's device. In some embodiments, this navigation interface may be particularized to a device category, device series, and/or device model which the user is known to possess or which is imaged by the image capture device of the user's device, while in other embodiments the interface may be generalized and may present a user with options to access all accessible documentation.

A second virtual button 920 may initiate a process to automatically identify a model of a device which is placed within a field of view of an image capture device associated with a system which is displaying the home screen 900. Selecting the second virtual button 920 may cause a live video feed to be displayed and may initiate analysis of that video feed by one or more machine learning models for the purpose of detecting and identifying a device category, device series, and/or device model of the electronic device depicted therein.

A third virtual button 930 may initiate a troubleshooting feature. Selecting the third virtual button 930 may also cause a live video feed to be displayed, but in this case may cause one or more machine learning models to classify an error and output one or more possible solutions to remediate the error. In some embodiments, this may also trigger a device identification process.

A fourth virtual button 940 may initiate a process to recognize a particular instance of a device. For example, a user who has three barcode scanners may want to log information related to one of the barcode scanners, and may select the fourth virtual button 940 to cause one or more machine learning models to analyze images of a target barcode scanner to determine which of the three known scanners is being depicted. The process may then access and/or display one or more records corresponding to the depicted known scanner, such as an error history associated with the depicted known scanner.

A fifth virtual button 950 may initiate a process which checks a warranty status of a presented device. Selecting the fifth virtual button 950 may also cause the process to recognize a particular instance of a device to start, and may trigger one or more queries of a database containing warranty information for one or more devices.

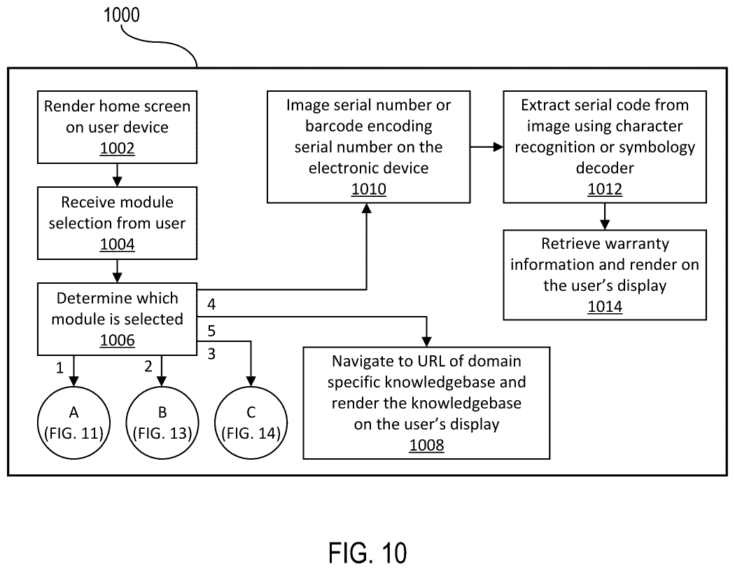

FIG. 10 illustrates a flowchart of an example method 1000 for employing a module of an example system (e.g., system 100 or 800), according to example embodiments of the present disclosure. It will be appreciated that the method 1000 is presented in such a manner as to provide clarity, and as such may exclude certain sub-steps and/or additional actions which may be performed in connection with the method 1000. It will also be appreciated that other example embodiments of the present disclosure may exclude any or all of the steps of the method 1000, and that the method 1000 constitutes one of many possible methods which may serve as example embodiments of the present disclosure.

At block 1002, an example processing device renders a home screen on a user device. For example, a processing device 110 may cause a display 150 to show a home screen 900 allowing a user to select a function of a system 100 for automating technical support with machine vision.

At block 1004, the example processing device receives a module selection from the user. For example, a selection of one of several virtual buttons (e.g., virtual buttons 910-950) may be received from the user, which may cause the system to execute one or more processes or functions associated with the module that corresponds to the selected virtual button.

At block 1006, the example processing device determines which module is selected. For example, the processing device 110 may receive touch input from the display 150 and initiate one or more processes which are associated with retrieving warranty data, such as device identification.

In response to selection of the virtual button 910 shown in FIG. 9, at block 1008, the example processing device navigates to a domain specific knowledgebase associated with at least one device category for which the system is programmed and renders the knowledgebase on the display. For example, the processing device 110 may, in response to a request for knowledgebase support for a printer device category, navigate to an internet domain associated with technical documentation about a printer device category, a printer series, and/or a printer model, then cause the display 150 to present the technical documentation.

In response to selection of the virtual button 950 shown in FIG. 9, at block 1010, an example image capture device images a serial number or a barcode encoding a serial number on the electronic device. For example, the image capture device 140 of the system 100 may capture an image of a barcode affixed to a printer, where the barcode contains a serial number of the imaged printer.

At block 1012, the example processing device decodes the barcode and extracts the serial number from the image using character recognition or a symbology decoder. For example, the processing device 110 may execute a module configured to decode barcodes, and may extract a payload of the barcode to determine a serial number of the barcode scanner.

At block 1014, the example processing device retrieves warranty information from a database and renders the warranty information on a display. For example, the processing device 110 may query the database 130 containing warranty information about several devices for warranty data about the barcode scanner. Upon receipt of the appropriate warranty information, the processing device 110 may direct the display 150 to present the warranty information to the user.

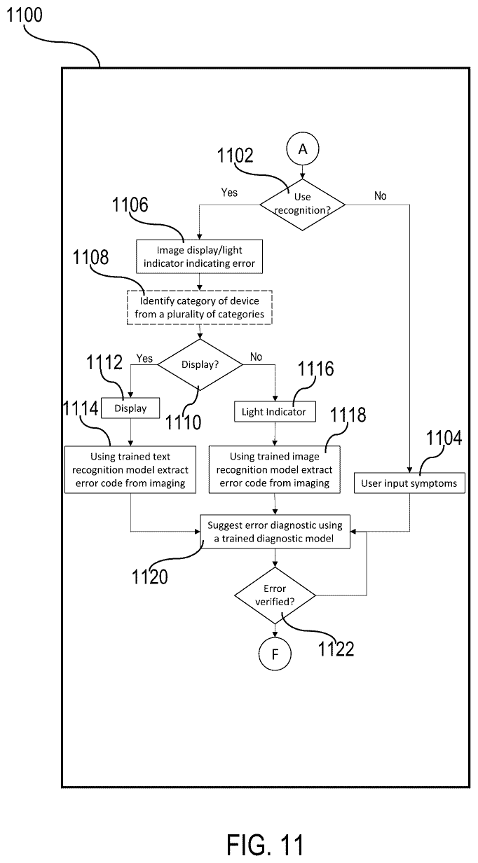

FIG. 11 illustrates a flowchart of an example method 1100 for detecting a device error, according to example embodiments of the present disclosure. It will be appreciated that the method 1100 is presented in such a manner as to provide clarity, and as such may exclude certain sub-steps and/or additional actions which may be performed in connection with the method 1100. It will also be appreciated that other example embodiments of the present disclosure may exclude any or all of the steps of the method 1100, and that the method 1100 constitutes one of many possible methods which may serve as example embodiments of the present disclosure. The method 1100 may be initiated as a selected module with reference to blocks 1002-1006 of FIG. 10, for example, in response to selection of the virtual button 930 shown in FIG. 9.

At block 1102, an example processing device determines whether to use machine vision to attempt to diagnose a problem in a target device. For example, the processing device 110 may present, via a display 150, a prompt to the user asking if the user wishes manually describe an error or whether the user wishes to utilize machine vision capabilities to determine the problem.

In response to a selection for a manually input (block 1102), at block 1104, the user manually inputs a description of the error. For example, the user may simply enter an error code displayed on a device screen. Alternatively, the user may describe an error in conversational language to a trained language model which may in turn consult a database to determine likely problems.

In response to a selection for a machine vision (block 1102), at block 1106, the example processing device images, via an image capture device, an output of the target device. The output can be indicative of an error in the target device and can be provided, for example, via a display of the target device or light of the target device.

At block 1108, the example processing device identifies a category of the device from a plurality of categories. For example, the processing device 110 may execute a first trained classifier model (e.g., classifier 620 shown in FIG. 6) which determines that a printer is being viewed based on features extracted from the image target device, then a second trained printer machine learning model (e.g., printer identification model 630 shown in FIG. 6) determines that a particular printer series and/or printer model is being viewed based on the features extracted from the imaged target device.

At block 1110, the example processing device determines whether the target device uses a display to render error information. For example, the processing device 110 may query a database 130 containing information about how the particular printer series and/or printer model outputs information about errors in operation (e.g., via a display or indicator lights).

At block 1112, the example processing device determines that the target device presents errors on a display. For example, the database 130 may indicate that the particular printer series and/or printer model of the imaged target device uses a display to present error codes to a user when there is an error in operation of the imaged printer.

At block 1114, the example processing device uses a trained text recognition model to extract the error code from an image of the display of the imaged printer. For example, the processing device 110 may execute a character recognition model trained to recognize text in a wide variety of fonts and styles in images and output a plain text transcription thereof.

At block 1116, the example processing device determines that the target device displays error codes via one or more lights. For example, the database 130 may indicate that the imaged printer possesses four multi-colored light emitting diode arrays for communicating errors.

At block 1118, the example processing device uses a trained image recognition model to extract an error code from the image. For example, the trained image recognition model might detect that the imaged printer is displaying two green lights followed by a red light and then a yellow light based on features extracted from images of the printer via the trained image recognition model. The trained image recognition model may then consult a database 130 to determine that the detected light pattern is indicative of a particular error code.

At block 1120, based on an output of the trained text recognition model of block 1114 or an output of the trained image recognition model of block 1118, the example processing device suggests an error diagnostic using a trained diagnostic machine learning model. For example, the processing device 110 may execute the trained diagnostic machine learning model to output the error being experienced by the imaged printer via the display.

At block 1122, the example processing device verifies whether the error output by the trained diagnostic machine learning model is accurate. For example, the processing device 110 may output the error via the display and may prompt the user for feedback and may receive feedback from the user indicative of whether the error diagnosis output by the trained diagnostic machine learning model is correct or incorrect. The feedback received from the user may be used to further train the diagnostic machine learning model. If the error diagnostic has been identified as being inaccurate at block 1122, the method 1100 can return to block 1120 where the trained diagnostic machine learning model uses the feedback and the output from block 1114 or block 1118 to generate another error diagnostic output.

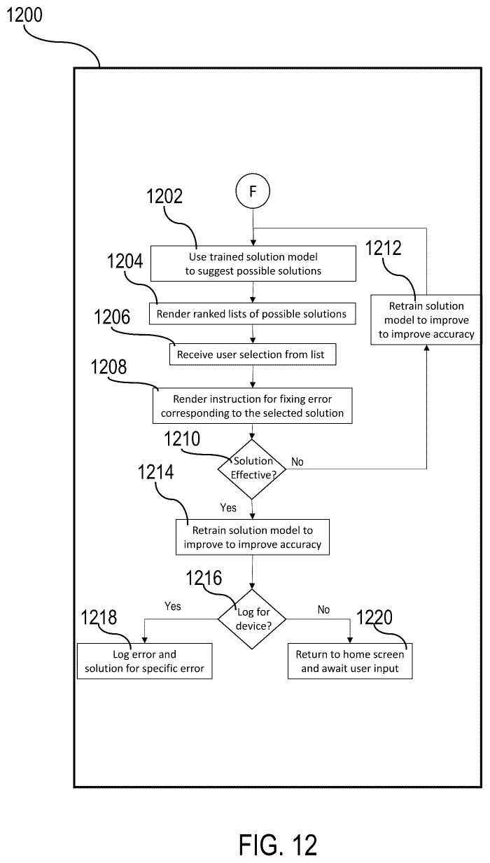

FIG. 12 illustrates a flowchart of an example method 1200 for generating solutions to errors and refining solution generation, according to example embodiments of the present disclosure. It will be appreciated that the method 1200 is presented in such a manner as to provide clarity, and as such may exclude certain sub-steps and/or additional actions which may be performed in connection with the method 1200. It will also be appreciated that other example embodiments of the present disclosure may exclude any or all of the steps of the method 1200, and that the method 1200 constitutes one of many possible methods which may serve as example embodiments of the present disclosure. The method 1200 may be a continuation of the method 1100 when the error diagnostic output by the trained diagnostic machine learning model has been verified as being accurate (at block 1122 of FIG. 11).

At block 1202, an example processing device uses a trained solution model to suggest possible solutions based on the verified error diagnostic (e.g., from block 1122 of FIG. 11). For example, a trained solution machine learning model may generate one or more possible solutions to remediate the verified error diagnostic. For example, the error experienced by the imaged printer can be diagnosed as a software error and possible solutions to remediate the error can include, for example, power cycling the device, updating the software, and firmware resetting the device.

At block 1204, the trained solution machine learning model can output a ranked list of the possible solutions. For example, the trained solution machine learning algorithm may determine that the power cycling solution is the most likely to succeed, followed by firmware resetting and then a software update.

At block 1206, the example processing device receives a user selection from the list of possible solutions. For example, the ranked list may be displayed on the touch display 150 allowing the user to select a desired course of action. In this example, the user selects the firmware resetting solution.

At block 1208, the example processing device renders instructions for fixing the error corresponding to the selected solution. As one example, the processing device 110 may direct the display 150 to present a video feed of the device overlayed with one or more augmented reality tags pointing out which buttons the user should hold down to perform a firmware reset. As another example, the processing device may render a sequence of steps to be followed by the user to fix the error based on the selected solution.

At block 1210, the example processing device determines whether the solution was effective. For example, the user may be presented with a prompt asking whether the solution was effective..

At block 1212, if the user responds that the solution was ineffective, the example processing device retrains the solution model to improve accuracy. For example, having suggested an ineffectual solution, a negative feedback may be applied to the ineffectual response within a training dataset, and the solution model may be completely retrained with the updated data set.

At block 1214, if the user responds that the solution was ineffective, the example processing device retrains the solution model to improve accuracy. For example, having suggested an effective solution, a positive feedback may be applied to the effective response within a training dataset, and the solution model may be incrementally trained with the new data.

At block 1216, the example processing device presents an option to log the error or not to the user. For example, the processing device 110 may be configured to render a message on the display 150 asking if the user wants to add the software error to an error history of the device.

At block 1218, the example processing device logs the error and the solution to the error. For example, the processing device 110 may send a summary of the error along with a summary of the effective solution to a database 130 which may store a record of errors for a plurality of devices. This data may be used to improve the solution model and may also be used for further product development.

At block 1220, the example processing device returns to the home screen and waits for user input. For example, having completed the diagnostic and successfully remediated the error, the system 100 may reset in preparation to perform another task.

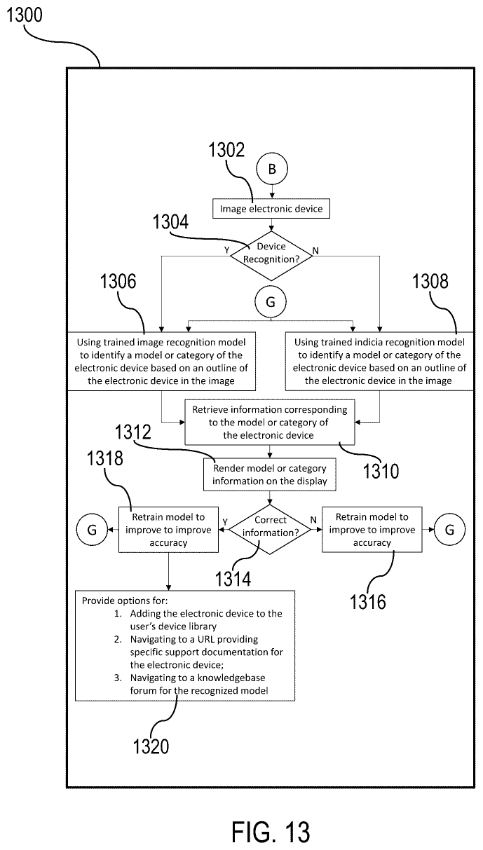

FIG. 13 illustrates a flowchart of an example method 1300 for recognizing an electronic device within a captured image and refining device recognition, according to example embodiments of the present disclosure. It will be appreciated that the method 1300 is presented in such a manner as to provide clarity, and as such may exclude certain sub-steps and/or additional actions which may be performed in connection with the method 1300. It will also be appreciated that other example embodiments of the present disclosure may exclude any or all of the steps of the method 1300, and that the method 1300 constitutes one of many possible methods which may serve as example embodiments of the present disclosure. The method 1300 may be initiated as a selected module with reference to blocks 1002-1006 of FIG. 10, for example, in response to selection of the virtual button 940 shown in FIG. 9.

At block 1302, an example image capture device captures an image of a target device. For example, the image capture device 140 of the system 100 may capture an image of an electronic device 310.

At block 1304, an example processing device determines whether device outline recognition or indicia recognition should be used. For example, the processing device 110 may identify and analyze any indicia of the electronic device 310 to determine whether an outline analysis is appropriate or may prompt a user via a display to select which type of recognition to use.

At block 1306, in response to device outline recognition being selected, the example processing device images the electronic device and uses the trained device outline recognition model to identify a device category, device series, and/or device model of the imaged electronic device based upon an outline of the electronic device in the image. For example, the recognition model may be trained to recognize the imaged electronic device 310 as belonging to particular device category, device series, and/or device model from several different perspectives (e.g., such as an image of the front, side, back, top, a combination thereof, and/or other perspectives).

At block 1308, in response to indicia recognition being selected, the example processing device uses a trained indicia recognition model to identify a model or category of the electronic device based upon an indicium of the electronic device in the image. For example, the indicia recognition model may detect human-readable characters on the side of the electronic device 310 that read “Z2000”, then process these characters with optical character recognition to yield a model name of the imaged electronic device, which can be used to identify the device category, the device series, and the device model. As an example, the indicia recognition model may detect a barcode on the side of the imaged electronic device 310. The barcode can contains a serial number as a payload. The serial number can be extracted by the processing device and the processing device can query a serial number database to retrieve a model name.

At block 1310, based on the trained device outline recognition model or the output of the trained indicia recognition model, the example processing device retrieves information corresponding to the model or category of the electronic device. For example, the processing device 110 may query the database 130 for documentation related to the imaged electronic device 310 (e.g., model “Z2000”).

At block 1312, the example processing device renders model or category information on a display. For example, the processing device 110 may direct the display 150 to render a stock image of the electronic retrieved from the device 130 with the model name. In some examples, additional details about the device model can be rendered with the stock image.

At block 1314, the processing device can prompt the user via the display 150 for feedback as to whether the displayed information matches the electronic device that was imaged and received an indication from the user as to whether the displayed information is correct or relevant to the imaged electronic device. For example, the user may indicate that the rendered stock image and other details correspond to a different device model) and is not relevant to the imaged electronic device 310.

At block 1316, the example processing device retrains the identification model to improve accuracy. For example, when the displayed information is for the correct device model, the processing device 110 may apply positive reinforcement to the training data before incrementally training the identification model.

At block 1318, the example processing device retrains the identification model to improve accuracy. For example, when the displayed information is not for the correct model, the processing device 110 may apply negative reinforcement to the training data before incrementally training the identification model.

At block 1320, the example processing device provides one or more options which may be performed in relation to the detected device. For example, the user may be presented with options to add the device to a library of known devices for the user, may be offered additional documentation about the device, and/or may be provided with a link to a knowledgebase forum about the detected device model. The device library may allow the user to enter information about the imaged electronic device, such as, e.g., a nickname for the electronic device, a location of the electronic device, permissions for the electronic device, and/or a serial number for the electronic device. Once the information is added, a record for the electronic device can be created in the device library of the processing device that allows the user to track and/or log errors that have occurred for that specific electronic device, solutions that have been used successfully to remediate the errors, warranty information for the specific electronic device, maintenance information for the electronic device, and/or other information about the electronic device.

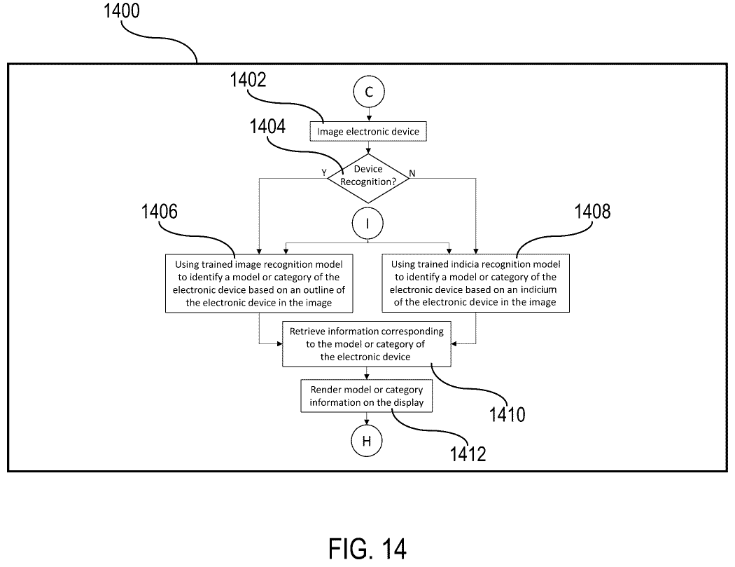

FIG. 14 illustrates a flowchart of an example method 1400 for retrieving and displaying documentation about an identified device, according to example embodiments of the present disclosure. It will be appreciated that the method 1400 is presented in such a manner as to provide clarity, and as such may exclude certain sub-steps and/or additional actions which may be performed in connection with the method 1400. It will also be appreciated that other example embodiments of the present disclosure may exclude any or all of the steps of the method 1400, and that the method 1400 constitutes one of many possible methods which may serve as example embodiments of the present disclosure. The method 1400 may be initiated as a selected module with reference to blocks 1002-1006 of FIG. 10, for example, in response to selection of the virtual button 920 shown in FIG. 9.

At block 1402, an example image capture device captures an image of a target electronic device. For example, the image capture device 140 of the system 100 may capture an image of a printer 310.

At block 1404, an example processing device determines whether device outline recognition or indicia recognition should be used. As an example, the processing device 110 may identify and analyze an outline of the printer 310 to determine whether an indicia analysis is necessary or appropriate or may prompt a user via a display to select which type of recognition to use.

At block 1406, in response to device outline recognition being selected, the example processing device uses the trained device outline recognition model to identify a device category, device series, and/or device model of the imaged electronic device based upon an outline of the electronic device in the image. For example, the recognition model may be trained to recognize the imaged electronic device 310 as belonging to particular device category, device series, and/or device model from several different perspectives (e.g., such as an image of the front, side, back, top, a combination thereof, and/or other perspectives).

At block 1408, the example processing device uses a trained indicia recognition model to identify a model or category of the electronic device based upon an indicium of the electronic device in the image. As an example, the indicia recognition model may detect human-readable characters on the side of the electronic device 310 that read “Z2000”, then process these characters with optical character recognition to yield a model name of the imaged electronic device, which can be used to identify the device category, the device series, and the device model. As an example, the indicia recognition model may detect a barcode on the side of the imaged electronic device 310. The barcode can contains a serial number as a payload, the serial number can be extracted, and then the processing device can query a serial number database to yield a model name.

At block 1410, based on the output of block 1406 or 1408, the example processing device retrieves information corresponding to the device model or device category of the imaged electronic device. For example, the processing device 110 may query a printer 310 documentation database 130 for documentation related to the imaged printer.

At block 1412, the example processing device renders model or category information on a display. For example, the processing device 110 may direct the display 150 to begin presenting a user manual for the Zprint thermal printer 310.

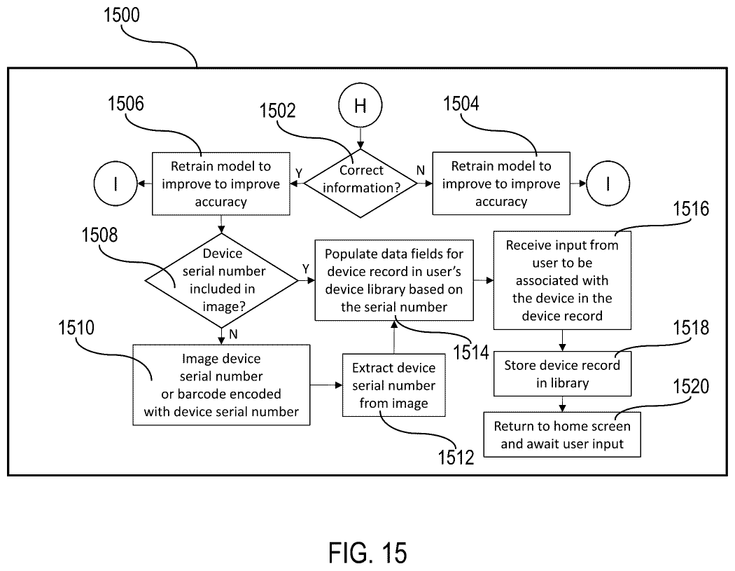

FIG. 15 illustrates a flowchart of an example method 1500 for storing device records, according to example embodiments of the present disclosure. It will be appreciated that the method 1500 is presented in such a manner as to provide clarity, and as such may exclude certain sub-steps and/or additional actions which may be performed in connection with the method 1500. It will also be appreciated that other example embodiments of the present disclosure may exclude any or all of the steps of the method 1500, and that the method 1500 constitutes one of many possible methods which may serve as example embodiments of the present disclosure. The method 1500 may be a continuation of the method 1400 after the model or category information for the imaged electronic device is rendered on the display (at block 1412 of FIG. 14).

At block 1502, a user indicates whether the model or category information provided by a system was correct or not. For example, the processing device may prompt the user via the display for feedback and the user provide an input indicating whether the model or category information that has been determined by the system is incorrect.

At block 1504, an example processing device retrains an identification model to improve accuracy. For example, when the displayed information is not for the correct model, the processing device 110 may apply negative reinforcement to the training data before fully retraining the identification model.

At block 1506, the example processing device retrains an identification model to improve accuracy. For example, when the displayed information is for the correct model, the processing device 110 may apply positive reinforcement to the training data before fully retraining the identification model.

At block 1508, the example processing device determines whether a target device's serial number is visible in an image. For example, the processing device 110 may analyze the image for indicia which contain a serial number as a payload.

At block 1510, the example processing device prompts a user to image the target device's serial number or a barcode encoded with the target device's serial number. For example, upon determining that a serial number is not visible, the processing device 110 may prompt the user via the display 150 to capture an image of the serial number.

At block 1512, the example processing device extracts the serial number from the image. For example, the processing device 110 may decode a 1D barcode contained in the image to extract a payload representative of the target device's 310 serial number.

At block 1514, the example processing device populates data fields for a device record in the user's device library based on the device's serial number. For example, the processing device 110 may use information associated with the serial number, including information contained in at least one database 130, to auto-populate the device record with information about the imaged target device, allow a user to record of an error or event associated with the target device 310, in the device record.

At block 1516, the example processing device receives input from the user to be associated with the device in the device record. For example, a user may assign themselves ownership of the device in a file intended for storage in a larger device library with multiple users.

At block 1518, the example processing device stores the device record in the device library, After which the device record can be used to record errors in operation for the target device. For example, a record of a paper jam may be stored in a database 130 containing historical data records for one or more devices, including a printer in which the jam occurred.

At block 1520, the example processing device returns to the home screen and awaits user input. For example, having completed the present tasks related to the target device 310, the processing device 110 may return to the home screen 900 in preparation for continuing use.

The above description refers to a block diagram of the accompanying drawings.

Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described.

However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A method, comprising:
training a plurality of machine learning algorithms for a device diagnostic and remediation system to generate at least a first trained model, a second trained model, and a third trained model, the first trained model being trained using a first set of training data that includes at least images of outputs of a set of electronic devices paired with error codes for the outputs, the second trained model being trained using a second set of training data that includes at least images of electronic devices including outputs indicative of error codes paired with error diagnostics, and the third trained model being trained using a third set of training data that includes at least a set of possible solutions paired with error diagnostics;
deploying the device diagnostic and remediation system on at least one of a user device or a server for execution; and
executing the device diagnostic and remediation system, wherein executing the device comprises:
receiving an image of an electronic device, the image including an output of the electronic device indicative of an error code associated with an operation of the electronic device;
executing the first trained model to recognize the error code from the output included in the image;
executing the second trained model to output an error diagnostic based on the error code recognized using the first trained model;
in response to verification of the error diagnostic output by the second trained model, executing a third trained model to output at least one solution to remedy an error of the electronic device corresponding to the error code recognized using the first trained model; and
retraining the third trained model based on whether the at least one solution was effective in remedying the error.

2. The method of claim 1, wherein the electronic device is a printer and the second trained model is trained based on training data that includes printer error titles, printer error descriptions, images of printers including outputs indicative of error codes, printer types, and seed printer error diagnostics.

3. The method of claim 1, wherein the electronic device is a printer and the third trained model is trained based on training data that includes printer error titles, groups of printers for which specific error diagnostics are applicable, cause of printer errors associated with printer error diagnostics, and seed solutions.

4. The method of claim 1, further comprising:
determining at least one of a model or a category of the electronic device from the image based on at least one of an outline of the electronic device and indicia on the electronic device;
retrieving technical documentation corresponding to the electronic device; and
displaying the technical documentation corresponding to the electronic device.

5. The method of claim 1, wherein the first trained model is configured to recognize the error code using at least one of text recognition or image recognition, and the method further comprises:
searching an index of error codes of the electronic device for the error code;
retrieving technical documentation corresponding to the error code; and
displaying the technical documentation corresponding to the error code.

6. The method of claim 1, further comprising:
capturing a live video feed of the electronic device;
displaying the live video feed of the electronic device; and
overlaying at least one augmented reality tag onto the live video feed, wherein the at least one augmented reality tag is instructive of a corrective action associated with the at least one solution output by the third trained model.

7. The method of claim 6, wherein the corrective action comprises at least two steps, and wherein the augmented reality tags are presented sequentially responsive to a preceding step being completed.

8. The method of claim 1, further comprising:
retrieving warranty information about the electronic device; and
displaying the warranty information.

9. The method of claim 1, further comprising:
storing a record of an error of the electronic device;
retrieving information about previous errors experienced by the electronic device;
predicting a future error of the electronic device, based on the previous errors of the electronic device; and
sending an alert indicative of the future error to a user.

10. The method of claim 1, further comprising:
capturing a live video feed of the electronic device;
displaying the live video feed of the electronic device; and
overlaying at least one augmented reality tag onto the live video feed, wherein the at least one augmented reality tag guides a user through a tutorial of use for the electronic device.

11. The method of claim 1, wherein the first trained model performs the determining by performing optical character recognition on an indicium affixed to the electronic device and querying, with the indicium, a database containing a library of indicia of known electronic devices to identify at least one of a model or category of the electronic device.

12. The method of claim 1, wherein the determining includes:
classifying, by first trained model, the electronic device by function based at least partially upon an outline of the electronic device captured in the image;
selecting, by the first trained model, a fourth trained model specialized to devices of the classified function based at least in part upon the classification; and
determining, by the fourth trained model, at least one of a particular instance or a model of the electronic device.

13. (canceled)

14. A system, comprising:
a memory;
an image capture device; and
a processing device, configured to:
receive an image of an electronic device from the image capture device, the image including an output of the electronic device indicative of an error code associated with an operation of the electronic device;
execute a first trained model to recognize the error code from the output included in the image, the first trained model being trained with a first set of training data including at least images of outputs of a set of electronic devices paired with error codes for the outputs;
execute a second trained model to output an error diagnostic based on the error code recognized using the first trained model, the second trained model being trained with a second set of training data including at least images of electronic devices including outputs indicative of error codes paired with error diagnostics;
in response to verification of the error diagnostic output by the second trained model, execute a third trained model to output at least one solution to remedy an error of the electronic device corresponding to the error code recognized using the first trained model, the third trained model being trained with a third set of training data; and
retrain the third trained model based on whether the at least one solution was effective in remedying the error.

15. The system of claim 14, wherein the electronic device is a printer and the second trained model is trained based on training data that includes printer error titles, printer error descriptions, images of printers including outputs indicative of printer error codes, printer types, and seed error diagnostics.

16. The system of claim 14, wherein the electronic device is a printer and the third trained model is trained based on training data that includes printer error titles, groups of printers for which specific error diagnostics are applicable, cause of printer errors associated with printer error diagnostics, and seed solutions.

17. (canceled)

18. The system of claim 13, wherein the processing device is further configured to:
detect, in the image, an error code of the electronic device;
determine, via character recognition, the error code;
search an index of error codes of the electronic device for the error code;
retrieve technical documentation corresponding to the error code; and
display the technical documentation corresponding to the error code.

19. The system of claim 14, wherein the processing device is further configured to:
capture, via the image capture device, a live video feed of the electronic device;
display the live video feed of the electronic device;
determine, based at least in part upon the technical documentation corresponding to the error code, a corrective action for the error code; and
overlay at least one augmented reality tag onto the live video feed, wherein the at least one augmented reality tag is instructive of how to perform the corrective action.

20. (canceled)

21. The system of claim 14, wherein the processing device is further configured to:
store a record of an error of the electronic device;
retrieve information about previous errors experienced by the electronic device;
predict a future error of the electronic device, based at least partially upon the previous errors of the electronic device; and
send an alert indicative of the future error to a user.

22. The system of claim 14, wherein the processing device is further configured to:
classify, by a first trained model, the electronic device by function based at least partially upon the outline of the electronic device captured in the image;
select, by the first trained model, a fourth trained model specialized to devices of the classified function based at least in part upon the classification; and
determine, by the fourth trained model, at least one of a particular instance or a model of the electronic device.

23. (canceled)

24. A non-transitory computer-readable medium storing instructions which, when executed by a processing device, cause the processing device to:
receive an image of an electronic device, the image including an output of the electronic device indicative of an error code associated with an operation of the electronic device;
execute a first trained model to recognize the error code from the output included in the image;
execute a second trained model to output an error diagnostic based on the error code recognized using the first trained model;
in response to verification of the error diagnostic output by the second trained model, execute a third trained model to output at least one solution to remedy an error of the electronic device corresponding to the error code recognized using the first trained model; and
retrain the third trained model based on whether the at least one solution was effective in remedying the error.
